(19) United States
(12) Patent Application Publication
(10) Pub. No.: US 2006/0256045 A1
(43) Pub. Date: Nov. 16, 2006

(54) Driving apparatus and driving method for electron emission device

(76) Inventors: Dong Hyup Jeon, Cheonan (KR); Duck Gu Cho, Changnyeong-gun (KR)

Correspondence Address: LEE & MORSE, P.C., 3141 FAIRVIEW PARK DRIVE, SUITE 500, FALLS CHURCH, VA, 22042, US

(21) Appl. No.: 11/389,024

(22) Filed: Mar. 27, 2006

(30) Foreign Application Priority Data
Apr. 27, 2005 (KR) 2005-35204

(51) Int. Cl. G09G 3/22

(52) U.S. Cl. 345/74.1

(57) ABSTRACT

Gamma correction for adjusting a white balance of an image may be performed and uniformity of an image being displayed may be improved by modulating a pulse width of a received video data signal. A driving apparatus for an electron emission device may include a controller for receiving an external video data signal and generating a plurality of clock signals based on the video data signal, and a data driver for receiving a corresponding one of the plurality of clock signals from the controller and modulating a pulse width of the received video data signal based on the corresponding clock signal.

### BACKGROUND OF THE INVENTION

1. Field of the Invention

The invention relates to a driving apparatus and a driving method for an electron emission device. More particularly, the invention relates to a driving apparatus and a driving method for an electron emission device enabling improved image uniformity by performing gamma correction to adjust a white balance of an image according to gray levels of pixels and/or sub-pixels.

2. Discussion of Related Art

Generally, flat panel displays (FPDs) employ a container-like structure formed by sealing together two substrates with a lateral wall extending between the two substrates. Materials for displaying images are arranged between the two substrates. As multimedia is becoming more and more popular, the demand for flat panel displays is increasing. Various types of flat panel displays such as liquid crystal displays (LCDs), plasma display panels (PDPs), electron emission displays, etc. are known.

Electron emission displays employ an electron beam for making a fluorescent material emit light similar to cathode ray tubes (CRTs). Thus, electron emission displays have the advantages of both CRTs and flat panel displays while also generally consuming a relatively low amount of power and displaying images with no or a relatively low amount of distortion. Electron emission displays generally have fast response time(s), high brightness levels, fine pitch and are relatively thin structures.

Electron emission devices generally employ a hot cathode or a cold cathode as an electron source. Examples of electron emission devices using cold cathodes include field emitter array (FEA) type displays, surface conduction emitter (SCE) type displays, metal-insulator-metal (MIM) type displays, metal-insulator-semiconductor (MIS) type displays, and ballistic electron surface emitting (BSE) type displays, etc.

Electron emission displays may have a triode structure including a cathode electrode, an anode electrode and a gate electrode. The cathode electrode, which may be used as a scan electrode, may be formed on a substrate. An insulating layer, with a hole formed therein, and the gate electrode, which may be used as a data electrode, may be sequentially formed on the cathode electrode. An emitter may be formed as the electron source within the hole in the insulating layer and may contact the cathode electrode.

In electron emission displays with such a configuration, the emitter may emit electrons when a high electric field is focused on the emitter. Such electron emission may be explained by the quantum tunneling effect. The electrons emitted from the emitter may be accelerated by a voltage applied between the cathode electrode and the anode electrode and may collide with red, green and blue (RGB) fluorescent materials provided on the anode electrode. Collisions of the emitted electrons with the red, green and blue fluorescent materials may cause the fluorescent materials to emit respectively colored light, thereby displaying a predetermined image.

Brightness of an image displayed as a result of the collisions of the emitted electrons with the fluorescent materials may vary based on values of an input digital video signal. The input digital video signal may have an 8—bit value for each of red (R), green (G) and blue (B) data. For example, the digital video signal may have a value ranging from 0(00000000₍₂₎₎ to 255 (14111111₍₂₎). Thus, such 8-bit input data signals may represent 256 possible values and may be used to represent a desired one of the 256 possible gray levels.

A pulse width modulation (PWM) method or a pulse amplitude modulation (PAM) method may be used to control the brightness represented by the values of the digital video signal.

The PWM method modulates the pulse width of a driving waveform applied to the respective data electrode based on the digital video signals input from a data electrode driver. For example, with such 8-bit input data signals, when the input digital video signal has a value of 255, the pulse width is maximized, thereby maximizing the allowable on-time and the brightness during a predetermined period of time. With such 8-bit input data signals, when the input digital video signal has a value of 127, the pulse width has about half of the maximum pulse width and about half of the maximum brightness during a predetermined period of time. Thus, the brightness of a pixel is controlled by adjusting the width of the pulses in the waveform that is applied to that pixel based on the corresponding input digital video signal.

In comparison to the PWM method, the PAM method keeps the pulse width constant regardless of the input digital video signal and modulates the pulse voltage level, i.e., the pulse amplitude, of the driving waveform applied to the data electrode in accordance with the input digital video signal. Thus, the brightness of a pixel is controlled by adjusting the amplitude of the pulses in the waveform that is applied to that pixel based on the corresponding input digital video signal.

FIG. 1 illustrates a block diagram of a known driving apparatus for a known electron emission device. As shown in FIG. 1, the driving apparatus includes a controller 110, a data driver 120 and a scan driver 130. The controller 110 receives a video data signal (Data) and generates one clock signal, e.g., a PWM clock signal (clock D), corresponding to the video data signal. The controller 110 also supplies a data signal corresponding to the input video data signal (Data) to the data driver 120. The controller 110 generates the PWM clock signal (clock D) based on a PWM clock converting index. The data driver 120 receives the PWM frequency clock signal (clock D) from the controller 110 and modulates the pulse width of the video data signal (data).

The electron emission device includes a display panel 140 that displays an image based on a PWM signal output from the data driver 120. The scan driver 130 supplies scan signals, e.g., on-time determination signals, to the display panel 140.

The data driver 120 includes a serial-parallel converter 121, a pulse width modulator 122, a polarity controller 123 and a level shifter 124. The serial-parallel converter 121 receives a serial video data signal (data) from the controller 110 and converts the serial video data signal (data) into parallel video data signals. As shown in FIG. 1, the parallel video data signal output by the serial-parallel converter 121 is processed by the pulse width modulator 122, the polarity controller 123 and the level shifter 124 before being supplied to a data line (not shown) of the display panel 140.

The pulse width modulator 122 receives both the parallel video data signal converted by the serial-parallel converter 121 and the PWM clock signal (clock D). The pulse width modulator 122 modulates the pulse width of the parallel video data signal in accordance with the PWM clock signal (clock D) and outputs a PWM signal.

The polarity controller 123 controls the polarity of the PWM signal output from the pulse width modulator 122. More particularly, the polarity controller 123 receives both the PWM signal from the pulse width modulator 122 and a polarity control signal (pol) from the controller 110, and selectively controls the polarity of the PWM signal on the basis of the polarity control signal (pol). The polarity controller 123 outputs the polarity controlled PWM signal to the level shifter 124.

The level shifter 124 receives the polarity controlled PWM signal and shifts the voltage level of the polarity controlled PWM signal. The level shifter 124 then supplies the shifted voltage level video data signal to the data electrode of the display panel 140.

The scan driver 130 applies a low or high signal to a predetermined row or scan line of the display panel 140 for a predetermined period, thereby selecting the row or scan line during the predetermined period. The scan driver 130 generates an on-time determination signal such as a blanking signal based on an on time (S on-time) signal from the controller 110.

The display panel 140 includes a plurality of data lines formed as one of gate and cathode electrodes, a plurality of scan lines formed as the other one of the gate and the cathode electrode, and a plurality of pixels formed in regions where the data lines intersect the scan lines. Each of the pixels includes overlapping portions of the gate electrode and the cathode electrode, and each pixel receives a data signal and a scan signal through the data line and the scan line, respectively. Pixels are selected in sequence by the scan signals input through the scan lines. The selected pixels receive the data signal through the data line and emit light, thereby displaying a predetermined image.

FIG. 2 illustrates a timing diagram of a scan signal and a PWM clock signal corresponding to a video data signal of known electron emission devices. As shown in FIG. 2, the clock signal (clock) generally used in determining the on-time in an active matrix type electron emission device is constantly supplied independently of the video data signal. In known electron emission devices, the on-time of the clock signal (clock) is equally controlled regardless of R, G and B characteristics.

Known electron emission devices generally provide good linearity, but it is generally difficult to implement gamma correction and/or other controls based on different characteristics of each of the colors, e.g., R, G and B characteristics. For example, it is difficult to adjust a white balance when one of the R, G and B sub-pixels is relatively bright or dark. Image quality, e.g., uniformity, may be hindered as a result of improper white balance.

The information disclosed above in this Background section is only provided to aid in the understanding of one or more aspects of the invention and is not to be considered nor construed as constituting prior art.

### SUMMARY OF THE INVENTION

The present invention is therefore directed to a driving apparatus and a driving method for an electron emission device, which substantially overcome one or more of the problems due to the limitations and disadvantages of the related art.

It is therefore a feature of an embodiment of the invention to provide a driving apparatus and a driving method for an electron emission device, in which uniformity of an image is improved by making a gamma correction to adjust a white balance based on gray levels of an input video signal.

It is therefore a feature of embodiments of the invention to provide a driving apparatus for an electron emission device including a controller receiving an external video data signal and generating a plurality of clock signals based on the video data signal, and a data driver receiving a corresponding one of the plurality of clock signals from the controller and modulating a pulse width of the received video data signal based on the corresponding clock signal.

The data driver may comprise a serial-parallel converter that receives a serial video data signal from the controller and converts the serial video data signal into a parallel video data signal, a pulse width modulator that receives both the parallel video data signal converted by the serial-parallel converter and the corresponding clock signal and modulates the pulse width of the parallel video data signal based on the corresponding clock signal, a polarity controller that controls a polarity of the signal output from the pulse width modulator, and a level shifter shifting a voltage level of the signal having the polarity controlled by the polarity controller.

The controller may determine a gray level of the received video data signal and may generate the plurality of the clock signals including a first clock signal, a second clock signal and a third clock signal according to gray levels of the video data signal. The first, second and third clock signals may be generated corresponding to the gray levels of the video data signal associated with R, G and B sub-pixels of a unit-pixel. The first clock signal may be adjusted corresponding to an on-time when the controller determines that the video data signal requires adjusting of a white balance for the R sub-pixel. The second clock signal may be adjusted corresponding to an on-time when the controller determines that the video data signal requires adjusting of a white balance for the G sub-pixel. The third clock signal may be adjusted corresponding to an on-time when the controller determines that the video data signal requires adjusting of a white balance for the B sub-pixel.

It is therefore a separate feature of embodiments of the invention to provide a method of driving an electron emission device that includes determining characteristics of and respectively generating first, second and third clock signals for R, G and B sub-pixels based on an externally received video data signal, selecting one of the generated clock signals, and modulating a PWM frequency of a sub-pixel driving signal using the selected one of the first, second and third clock signals, wherein the sub-pixel driving signal is based on the externally received video data signal and drives one of the R, G and B sub-pixels.

In embodiments of the invention, modulated pulses of the sub-pixel driving signal may be counted, and a gray level of the corresponding one of the sub-pixels may be represented corresponding to an amount of time that elapses while a predetermined number of the modulated pulses are counted. In embodiments of the invention, modulated pulses of the sub-pixel driving signal may be counted, and a gray level of the corresponding one of the sub-pixels may be represented by increasing a voltage level corresponding to an amount of time that elapses while a predetermined number of the modulated pulses are counted.

The PWM frequency of the sub-pixel driving signal corresponding to the R sub-pixel may be converted based on the selected first clock signal corresponding to the R sub-pixel. The PWM frequency of the sub-pixel driving signal corresponding to the G sub-pixel may be converted based on the selected second clock signal corresponding to the G sub-pixel. The PWM frequency of the sub-pixel driving signal corresponding to the B sub-pixel may be converted based on the selected third clock signal corresponding to the B sub-pixel.

It is therefore a separate feature of embodiments of the invention to provide a method of driving an electron emission device involving receiving an input video data signal, determining a gray level of each sub-pixel of a unit-pixel based on the received input video data signal, generating a clock signal for each of the sub-pixels of the unit-pixel based on the determined gray levels, and modulating a data signal corresponding to each of the sub-pixels of a unit-pixel based on the corresponding one of the generated clock signals.

Each unit-pixel may include a red sub-pixel, a green sub-pixel and a blue sub-pixel and determining the gray levels of each of the sub-pixels of the unit-pixel may involve determining a gray level of each of the red sub-pixel, the green sub-pixel and the blue sub-pixel relative to each other. Generating a clock signal may involve generating a clock signal based on the determined gray levels of the sub-pixels such that a clock signal having a low frequency relative to frequencies of the other clock signals is generated for the sub-pixel having the highest relative gray value. Generating a clock signal may involve generating clock signals based on the determined gray levels of the sub-pixels such that a clock signal having a high frequency relative to frequencies of the other clock signals is generated for the sub-pixel having the lowest relative gray value.

Generating the clock signals may involve generating a clock signal based on the determined gray levels of the sub-pixels such that a first clock signal having a low frequency relative to frequencies of a second clock signal and a third clock signal is generated for the sub-pixel having the highest relative gray value, where the third clock signal has a frequency less than both the first clock signal, and the second clock signal is generated for the sub-pixel having the lowest relative gray value and the second clock signal having a frequency less than the first clock signal and greater than the third clock signal is generated for the remaining one the red sub-pixel, the blue sub-pixel and the green sub-pixel of the unit-pixel.

### BRIEF DESCRIPTION OF THE DRAWINGS

The above and other features and advantages of the present invention will become more apparent to those of ordinary skill in the art by describing in detail exemplary embodiments thereof with reference to the attached drawings in which:

FIG. 1 illustrates a block diagram of a known driving apparatus for an electron emission device;

FIG. 2 illustrates a timing diagram of a scan signal and a PWM clock signal corresponding to a video data signal of the driving apparatus shown in FIG. 1;

FIG. 3 illustrates a block diagram of an exemplary embodiment of a driving apparatus for an electron emission device employing one or more aspects of the invention; and

FIG. 4 illustrates timing diagrams of exemplary scan signals and exemplary PWM clock signals corresponding to respective input video data signals according to one or more aspects of the invention.

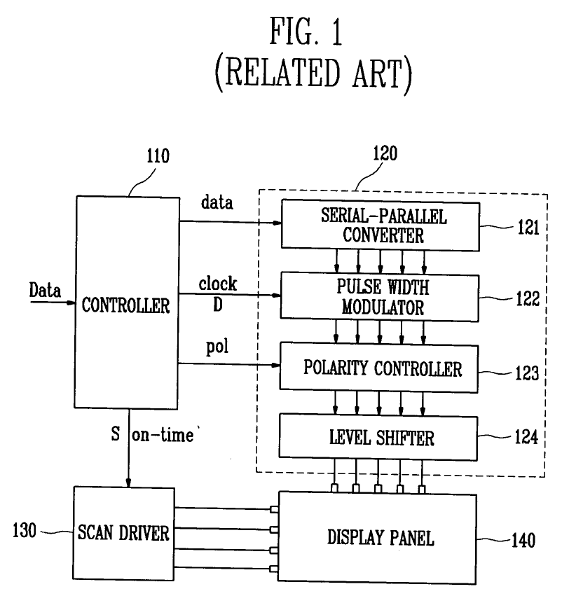

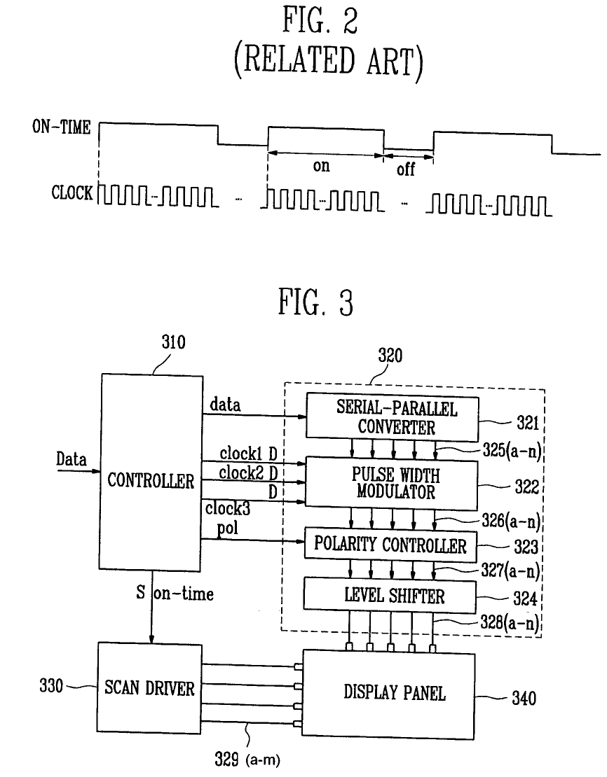

### DETAILED DESCRIPTION OF THE INVENTION

Korean Patent Application No. 2005-35204, filed on Apr. 27, 2005, in the Korean Intellectual Property Office, and entitled, “Driving Apparatus and Driving Method for Electron Emission Device,” is incorporated by reference herein in its entirety.

The present invention will now be described more fully hereinafter with reference to the accompanying drawings, in which exemplary embodiments of the invention are shown. The invention may, however, be embodied in different forms and should not be construed as limited to the embodiments set forth herein. Rather, these embodiments are provided so that this disclosure will be thorough and complete, and will fully convey the scope of the invention to those skilled in the art. In the figures, the dimensions of layers and regions are exaggerated for clarity of illustration. It will also be understood that when a layer is referred to as being “on” another layer or substrate, it can be directly on the other layer or substrate, or intervening layers may also be present. Further, it will be understood that when a layer is referred to as being “under” another layer, it can be directly under, and one or more intervening layers may also be present. In addition, it will also be understood that when a layer is referred to as being “between” two layers, it can be the only layer between the two layers, or one or more intervening layers may also be present. Like reference numerals refer to like elements throughout.

FIG. 3 illustrates a block diagram of a driving apparatus for an electron emission device according to an exemplary embodiment of the invention. As shown in FIG. 3, a driving apparatus for the electron emission device may include a controller 310, a data driver 320, a scan driver 330 and a display panel 340. The controller 310 may receive an externally supplied video data signal (Data) and may generate a first PWM clock signal (clock1 D), a second PWM clock signal (clock2 D) and a third PWM clock signal (clock3 D) corresponding to the video data signal (Data). The data driver 320 may receive the first, second and third clock signals (clock1 D, clock2 D and clock3 D) from the controller 310 and may modulate the pulse width of the video data signal (data).

The electron emission device may include a display panel 340 for displaying an image based on voltage shifted PWM signals 328(a-n) output from the data driver 320 and a scan driver 330 for supplying scan signals 329(a-m) to the display panel 340. The display panel 340 may include a plurality of data lines (a-n data lines) formed as one of gate and cathode electrodes, a plurality of scan lines (a-m data lines) formed as the other ones of the gate and the cathode electrodes. A plurality of pixels may be formed in regions where the data lines intersect the scan lines. Each pixel may include corresponding portions of the respective gate electrode and the respective cathode electrode. Each pixel may receive a data signal and a scan signal through the corresponding data line and the corresponding scan line, respectively. Pixel lines may be selected in sequence by the scan signals input through the scan lines and the selected pixel lines may work together with data signals received through the data lines so that selected pixels of the display panel emit light, thereby displaying a predetermined image.

The controller 310 may determine a gray level of a unit-pixel of the received video data signal (Data) and may generate the first, second and third clock signals (clock1 D, clock2 D and clock3 D) according to gray levels of each sub-pixel of the unit-pixel. In embodiments of the invention, the first, second and third clock signals (clock1 D, clock2 D and clock3 D) may be generated depending on the gray levels of R, G and B sub-pixels.

The controller 310 may determine the gray level of the video data signal and may select one of the first, second and third clock signals of the R, G and B sub-pixels, thereby outputting the selected one of the clock signals (clock1 D, clock2 D or clock3 D).

For example, when the controller 310 determines that the video data signal (data) is in need of adjusting a white balance for the R sub-pixel, the first clock signal (clock1 D) may be adjusted corresponding to an on-time. When the controller 310 determines that the video data signal is in need of adjusting a white balance for the G sub-pixel, the second clock signal (clock2 D) may be adjusted corresponding to an on-time. When the controller 310 determines that the video data signal is in need of adjusting a white balance for the B sub-pixel, the third clock signal (clock3 D) may be adjusted corresponding to an on-time.

As shown in FIG. 3, the data driver 320 may include a serial-parallel converter 321, a pulse width modulator 322, a polarity controller 323 and a level shifter 324.

The serial-parallel converter 321 may receive a serial video data signal (data) from the controller 310 and may convert the serial video data signal (data) into parallel video data signals 325(a-n). The respective parallel video data signals 325(a-n) may be supplied to respective data lines of the display panel 340.

The pulse width modulator 322 may modulate pulse widths of the respective parallel video data signals 325(a-n) in accordance with the respective one of the PWM clock signals (clock1 D, clock2 D or clock3 D), thereby outputting PWM signals 326(a-n). The pulse width modulator 322 may receive the PWM clock signals (clock1 D, clock2 D, clock3 D) from the controller 310. The controller 310 may include a PWM clock converting index (not shown), and the PWM clock signals (clock1 D, clock2 D, clock3 D) may be output based on the PWM clock converting index.

The polarity controller 323 may control the polarity of the PWM signals 326(a-n) and may output corresponding polarity controlled PWM signals 327(a-n). In particular, the polarity controller 323 may receive a polarity control signal (pol) from the controller 310 and the PWM signals 326(a-n) and may selectively control polarities of the PWM signals 326(a-n) on the basis of the polarity control signal (pol). The polarity controller may output polarity controlled PWM signals 327(a-n).

The level shifter 324 may respectively shift voltage levels of the polarity controlled PWM signals 327(a-n) and may output the corresponding voltage shifted PWM signals 328(a-n). The level shifter 324 may shift a voltage level of polarity controlled PWM signals 327(a-n) and may output the voltage shifted PWM signals 328(a-n) to the respective data lines (not shown) of the display panel 340.

The scan driver 330 may apply scan signals 329(a-m), e.g., low and/or high signals, on-time determination signals, to the display panel 340 based on an on-time signal (S on-time) from the controller. The scan driver 330 may apply a low or high signal to a predetermined row of the display panel 340 through a scan line (not shown) of the display 340 for a predetermined period, thereby selecting the row of the display panel during the predetermined period. The scan driver 330 may generate on-time determination signals such as blanking signals based on an on-time signal (S on-time) from the controller 310.

In embodiments of the invention, a PWM frequency of a signal, e.g., a video data signal, a clock signal, may be changed based on the gray level of a unit image, e.g., the gray level of the video data signal (data) corresponding to a unit frame. More particularly, in embodiments of the invention, a PWM frequency of a video data signal associated with each color or sub-pixel of a unit-pixel may be changed based on the gray level of the video data signal associated with each color or sub-pixel. The respective PWM clock signal and the respective on-time signal (S on-time) generated by the controller 310 may be applied to the data driver and the scan driver, respectively. Below, a process of setting/changing the PWM frequency of a signal will be described.

First, for the received video data signal (data), the controller 310 may determine settings/characteristics of a clock signal (clock1 D, clock2 D, clock3 D) for each sub-pixel of a unit-pixel, e.g., R, G and B sub-pixels. Then, the controller 310 may generate, based on the determined settings/characteristics, the first, second and third clock signals (clock1 D, clock2 D, clock3 D) corresponding to the R, G and B sub-pixels, respectively.

One of the first, second and third clock signals (clock1 D, clock2 D, clock3 D) may be selected based on the video data signal (data) being processed. Then, the video data signal (data) may be modulated or set in accordance with the respective selected one of the clock signals (clock1 D, clock2 D, clock3 D).

For example, the PWM frequency of the video data signal for the R sub-pixel may be set/changed depending on the respective clock signal, e.g., clock1 D, which may correspond to the video data signal for the R sub-pixel. The PWM frequency of the video data signal for the G sub-pixel may be set/changed depending on the clock signal, e.g., clock2 D, which may correspond to the video data signal for the G sub-pixel. The PWM frequency of the video data signal for the B sub-pixel may be set/changed depending on the clock signal, e.g., clock3 D, which may correspond to the video data signal for the B sub-pixel.

Accordingly, the gray level of the video data signals may be represented corresponding to an amount of on-time of a signal based on the occurrence of a predetermined number of pulses of the respective PWM video data signal. In embodiments of the invention, the gray level of the video data signal may be represented by changing a total voltage level based on the counted number of pulses according to the converted PWM frequency.

Output characteristics of the R, G and B sub-pixels may be different from each other at a gray level of the video data signal. In embodiments of the invention, separate clock signals (clock1, clock2, clock3) may be generated for each sub-pixel, e.g., R, G and B sub-pixels. Thus, the white balance of the unit-pixel may be adjusted based on the gray levels and the characteristics of the R, G and B sub-pixels.

For example, when a predetermined sub-pixel of a unit-pixel is bright or dark relative to other sub-pixels of the unit-pixel, the white balance of the unit-pixel may be adjusted by controlling only the corresponding sub-pixel or some or all of the respective clock signals associated with sub-pixels of the unit-pixel.

In embodiments of the invention, gamma correction may be separately applied to the R, G and B sub-pixels, thereby enabling more accurate gamma correction.

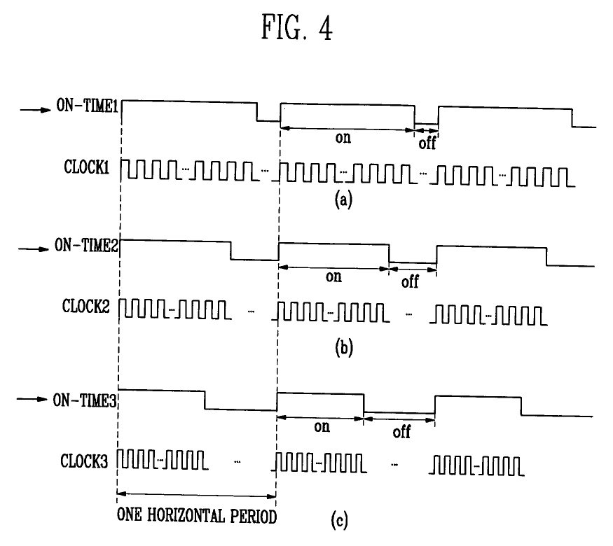

FIGS. 4(a)-4(c) illustrate timing diagrams of scan signals (on-time1, on-time2, on-time3) and clock signals (clock1, clock2, clock3) corresponding to video data signals of the electron emission device according to an exemplary embodiment of the invention. FIG. 4(a) corresponds to a case of a video data signal having a relatively low gray level. FIG. 4(b) corresponds to a case of a video data signal having a gray level in between the gray level of the signal shown in FIG. 4(a) and greater than a gray level of the signal shown in FIG. 4(c). FIG. 4(c) corresponds to a case of a video data signal having a gray level higher than the signals shown in FIGS. 4(a) and 4(b).

As discussed above, FIG. 4(a) corresponds to a video data signal of a sub-pixel having a relatively low gray level, e.g., a white mode. As shown in FIG. 4(a), a corresponding on-time signal (on-time1) being supplied to the scan driver 330 may have a relatively high level.

In embodiments of the invention, as discussed above, a PWM frequency of a corresponding clock signal (clock1) may be determined and set based on output characteristics of sub-pixels of a unit-pixel and gray level values of the respective sub-pixels of the unit-pixel. In the case of a relatively low gray level, as shown in FIG. 4(a), the corresponding clock signal (clock1) may be set with a relatively low frequency.

Thus, in embodiments of the invention, to improve image quality, e.g., image uniformity and/or white balance, the “on” time of the relatively low gray level sub-pixel may be increased while maintaining the gray level(s) of the sub-pixel(s). More particularly, the frequency of the relatively low frequency clock signal (clock1) may be set in view of the output characteristics of the sub-pixels of the unit-pixel in order to improve characteristics, e.g., uniformity and/or white balance, of the image being displayed by the unit-pixel.

With the clock signal (clock1) being set at the relatively low frequency, the amount of time that the clock signal (clock1) takes to carry out a predetermined number of pulses, i.e., clock counts, is greater than an amount of time that a higher frequency clock signal, e.g., clock2 or clock3, would take to carry out the same predetermined number of pulses.

Thus, in embodiments of the invention, a clock signal, e.g., clock1, corresponding to the video data signal of the sub-pixel having a relatively low gray level in relation to other sub-pixels of a unit-pixel, may be set with a lower PWM frequency in relation to the PWM frequency of other pixels or sub-pixels, e.g., sub-pixels of the unit-pixel, to increase the on-time and decrease the off-time for driving the electron emission device associated with the sub-pixel having the relatively low gray level.

As discussed above, FIG. 4(b) corresponds to a video data signal having a gray level between the gray levels of the signals shown in FIGS. 4(a) and 4(c). As shown in FIG. 4(b), a corresponding on-time signal (on-time2) being supplied to the scan driver 330 may have a lower level than on-time1 of FIG. 4(a). A clock signal (clock2) having a frequency that is higher than the frequency of the clock signal (clock1) may be employed with the relatively lower level of the on-time signal (on-time2) corresponding to the video data signal having the gray level between the gray levels of the signals shown in FIGS. 4(a) and 4(c).

As discussed above, FIG. 4(c) corresponds to a video data signal having a relatively high gray level. As shown in FIG. 4(c), a corresponding on-time signal (on-time3) being supplied to the scan driver 330 may have a lower level than on-time1 of FIG. 4(a) and on-time2 of FIG. 4(b).

In embodiments of the invention, as discussed above, a PWM frequency of a corresponding clock signal (clock3) may be determined and set based on output characteristics of sub-pixels of a unit-pixel and gray level values of the respective sub-pixels of the unit-pixel. In the case of a relatively high gray level, as shown in FIG. 4(c), the corresponding clock signal (clock3) may be set with a relatively high frequency.

Thus, in embodiments of the invention, to improve image quality, e.g., image uniformity and/or white balance, the “on” time of the relatively high gray level sub-pixel may be decreased while maintaining the gray level(s) of the sub-pixel(s). More particularly, the frequency of the relatively high frequency clock signal (clock3) may be set in view of the output characteristics of the sub-pixels of the unit-pixel in order to improve characteristics, e.g., uniformity and/or white balance, of the image being displayed by the unit-pixel.

With the clock signal (clock3) being set at the relatively high frequency, the amount of time that the clock signal (clock3) takes to carry out a predetermined number of pulses, i.e., clock counts, is less than an amount of time that the lower frequency clock signal, e.g., clock2 or clock 3, would take to carry out the same predetermined number of pulses.

Thus, in embodiments of the invention, a clock signal, e.g., clock3, corresponding to the video data signal of the sub-pixel having a relatively high gray level in relation to other sub-pixels of a unit-pixel, may be set with a higher PWM frequency in relation to the PWM frequency of other pixels or sub-pixels, e.g., sub-pixels of the unit-pixel, to decrease the on-time and increase the off-time for driving the electron emission device associated with the sub-pixel having the relatively high gray level.

A general PWM type driving method counts the number of PWM clocks and represents a gray level corresponding to a lasting time of the PWM clocks. The driving method according to one or more aspects of the present invention represents the gray level by converting the PWM frequency according to unit video data signals based on the clock signal determined according to the input unit video data signals, so that the video data signal having the relatively high gray level generates a lower amount of electron emission in the respective sub-pixel and the video data signal having the relatively low gray level generates a greater amount of electron emission in the respective sub-pixel.

In embodiments of the invention, the PWM frequency of respective video data signals may be selectively set based on a corresponding clock signal inputted for the video data signal. The corresponding clock signals may be determined and outputted to the data driver 320 based on the gray level of the respective video data signal. For example, the PWM frequency, corresponding to the gray level of a video data signal, may be set by outputting first, second and third clock signals corresponding to the R, G and B sub-pixels associated with the video data signal, thereby enabling white balance adjustment and gamma correction.

As described above, one or more aspects of the invention provides a driving apparatus and/or a driving method employable by an electron emission device for improving uniformity of an image by enabling gamma correction for adjusting a white balance of the pixels in a display according to gray levels of input signals.

Exemplary embodiments of the present invention have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. A driving apparatus for an electron emission device, comprising:
a controller receiving an external video data signal and generating a plurality of clock signals based on the video data signal; and
a data driver receiving a corresponding one of the plurality of clock signals from the controller and modulating a pulse width of the received video data signal based on the corresponding clock signal.

2. The driving apparatus as claimed in claim 1, wherein the data driver comprises:
a serial-parallel converter receiving a serial video data signal from the controller and converting the serial video data signal into a parallel video data signal;
a pulse width modulator receiving both the parallel video data signal converted by the serial-parallel converter and the corresponding clock signal and modulating the pulse width of the parallel video data signal based on the corresponding clock signal;
a polarity controller controlling a polarity of the signal output from the pulse width modulator; and
a level shifter shifting a voltage level of the signal having the polarity controlled by the polarity controller.

3. The driving apparatus as claimed in claim 1, wherein the controller determines a gray level of the received video data signal and generates the plurality of the clock signals including a first clock signal, a second clock signal and a third clock signal according to gray levels of the video data signal.

4. The driving apparatus as claimed in claim 3, wherein the first, second and third clock signals are generated corresponding to the gray levels of the video data signal associated with R, G and B sub-pixels of a unit-pixel.

5. The driving apparatus as claimed in claim 3, wherein the controller determines a gray level of the received video data signal and selectively outputs one of the first, second and third clock signals based on gray levels of R, G and B sub-pixels of a unit-pixel.

6. The driving apparatus as claimed in claim 5, wherein the first clock signal is adjusted corresponding to an on-time when the controller determines that the video data signal requires adjusting of a white balance for the R sub-pixel.

7. The driving apparatus as claimed in claim 5, wherein the second clock signal is adjusted corresponding to an on-time when the controller determines that the video data signal requires adjusting of a white balance for the G sub-pixel.

8. The driving apparatus as claimed in claim 5, wherein the third clock signal is adjusted corresponding to an on-time when the controller determines that the video data signal requires adjusting of a white balance for the B sub-pixel.

9. A method of driving an electron emission device, comprising:
determining characteristics of and respectively generating first, second and third clock signals for R, G and B sub-pixels based on an externally received video data signal;
selecting one of the generated clock signals; and
modulating a PWM frequency of a sub-pixel driving signal using the selected one of the first, second and third clock signals, the sub-pixel driving signal being based on the externally received video data signal and driving one of the R, G and B sub-pixels.

10. The method as claimed in claim 9, wherein modulated pulses of the sub-pixel driving signal are counted, and a gray level of the corresponding one of the sub-pixels is represented corresponding to an amount of time that elapses while a predetermined number of the modulated pulses are counted.

11. The method as claimed in claim 9, wherein modulated pulses of the sub-pixel driving signal are counted, and a gray level of the corresponding one of the sub-pixels is represented by increasing a voltage level corresponding to an amount of time that elapses while a predetermined number of the modulated pulses are counted.

12. The method as claimed in claim 9, wherein the PWM frequency of the sub-pixel driving signal corresponding to the R sub-pixel is converted based on the selected first clock signal corresponding to the R sub-pixel.

13. The method as claimed in claim 9, wherein the PWM frequency of the sub-pixel driving signal corresponding to the G sub-pixel is converted based on the selected second clock signal corresponding to the G sub-pixel.

14. The method as claimed in claim 9, wherein the PWM frequency of the sub-pixel driving signal corresponding to the B sub-pixel is converted based on the selected third clock signal corresponding to the B sub-pixel.

15. A method of driving an electron emission device, comprising:
receiving an input video data signal;
determining a gray level of each sub-pixel of a unit-pixel based on the received input video data signal;
generating a clock signal for each of the sub-pixels of the unit-pixel based on the determined gray levels; and
modulating a data signal corresponding to each of the sub-pixels of a unit-pixel based on the corresponding one of the generated clock signals.

16. The method as claimed in claim 15, wherein the unit-pixel includes a red sub-pixel, a green sub-pixel and a blue sub-pixel, and determining the gray levels of each of the sub-pixels of the unit-pixel includes determining a gray level of each of the red sub-pixel, the green sub-pixel and the blue sub-pixel relative to each other.

17. The method as claimed in claim 16, wherein generating a clock signal includes generating a clock signal based on the determined gray levels of the sub-pixels such that a clock signal having a low frequency relative to frequencies of other ones of the clock signals is generated for the sub-pixel having the highest relative gray value.

18. The method as claimed in claim 16, wherein generating a clock signal includes generating a clock signal based on the determined gray levels of the sub-pixels such that a clock signal having a high frequency relative to frequencies of other ones of the clock signals is generated for the sub-pixel having the lowest relative gray value.

19. The method as claimed in claim 16, wherein generating a clock signal includes generating a clock signal based on the determined gray levels of the sub-pixels such that a first clock signal having a low frequency relative to frequencies of a second clock signal and a third clock signal is generated for the sub-pixel having the highest relative gray value, the third clock signal having a frequency less than both the first clock signal and the second clock signal is generated for the sub-pixel having the lowest relative gray value and the second clock signal having a frequency less than the first clock signal and greater than the third clock signal is generated for the remaining one the red sub-pixel, the blue sub-pixel and the green sub-pixel of the unit-pixel.
